(19) United States
(12) Patent Application Publication
(10) Pub. No.: US 2018/0137376 A1
(43) Pub. Date: May 17, 2018

(54) STATE ESTIMATING METHOD AND APPARATUS

(71) Applicant: DENSO CORPORATION, Kariya-city (JP)

(72) Inventors: Shunsuke Suzuki, Kariya-city (JP); Arata Takahashi, Nagakute-shi (JP)

(21) Appl. No.: 15/724,123

(22) Filed: Oct. 3, 2017

(30) Foreign Application Priority Data
Oct. 4, 2016 (JP) 2016-196626

(51) Int. Cl. G06K 9/00; G06T 7/277; G08G 1/16

(52) U.S. Cl. CPC G06K 9/00805; G06K 9/00369; G06K 9/00798; G06T 2207/30261; G08G 1/166; G08G 1/167; G06T 7/277

(57) ABSTRACT

A state estimation apparatus for estimating, based on an output of an image sensor, an estimated value of an estimation target using a Kalman filter extracts, from the output of the image sensor, an observation to the Kalman filter. The state estimation apparatus also obtains, from the output of a vehicular motion sensor that is different from the image sensor, a time update input related to the state of the estimation target. The time update input is used by the Kalman filter. The state estimation apparatus obtains, based on the observation and the time update input, the estimated value of the state of the estimation target using the Kalman filter. The Kalman filter is comprised of system noise to which a previously defined correction has been added. The previously defined correction addresses variations of an error in the vehicular motion sensor.

### CROSS REFERENCE TO RELATED APPLICATION

This application is based on and claims the benefit of priority from Japanese Patent Application 2016-196626 filed on Oct. 4, 2016, the disclosures of which are incorporated in its entirety herein by reference.

### TECHNICAL FIELD

The present disclosure relates to state estimation methods and apparatuses for estimating the state of a target.

### BACKGROUND

A travelling road recognition apparatus disclosed in Japanese Patent Application Publication No. 2002-109695, which will be referred to as a first published document, uses an extended Kalman filter in calculating parameters indicative of the shape of a road in front of a vehicle; the extended Kalman filter has temporal continuity and spatial continuity, and also has stochastic rationality with regard to calculation of the parameters.

A vehicular information estimation apparatus disclosed in Japanese Patent Application Publication No. 2013-129289, which will be referred to as a second published document, uses a Kalman filter in inputting, into an estimation model, observations output from observation means and a level of reliability of each observation to thereby estimate the state quantities of a vehicle.

### SUMMARY

Errors included in inputs, which are input to a time update model used by such a conventional Kalman filter, may however cause the estimate values estimated by the conventional Kalman filter to contain steady-state deviations; the inputs include a steering angle in each of the first and second published documents.

This may be because the conventional Kalman filter is designed to address or cope with only system-specific noise, i.e. system noise, and observation noise, so that the conventional Kalman filter may be designed independently of errors included in the inputs to the time update model. In other words, because the conventional Kalman filter is designed on the precondition that no errors are included in the inputs to the time update model, errors contained in the inputs to the time update model may cause estimation errors to be included in the estimate values estimated by the conventional Kalman filter.

An exemplary aspect of the present disclosure aims to provide state estimating methods and apparatuses, each of which is capable of obtaining, based on a Kalman filter, an estimate value of the state of an estimated target with a higher accuracy even if there is an error included in an input to the Kalman filter.

A state estimation apparatus according to a first aspect of the present disclosure is a state estimation apparatus for estimating, based on an output of an image sensor, a state of an estimation target using a Kalman filter. The state estimation apparatus includes an extracting unit configured to extract, from the output of the image sensor, an observation to be input to the Kalman filter, and an obtaining unit configured to obtain, from an output of a vehicular motion sensor that is different from the image sensor, a time update input related to the state of the estimation target. The time update input is used by the Kalman filter. The state estimation apparatus includes an estimator configured to obtain, based on the observation and the time update input, an estimated value of the state of the estimation target using the Kalman filter. The Kalman filter includes system noise to which a previously defined correction has been added. The previously defined correction addresses variations of an error in the vehicular motion sensor.

A state estimation method according to a second aspect of the present disclosure is a state estimation method of estimating, based on a Kalman filter, a state of an estimation target as a function of an output of an image sensor, an output of a vehicular motion sensor different from the image sensor, and a previously defined correction that addresses variations of an error in the vehicular motion sensor. The state estimation method includes at least the steps of

1. Extracting, from the output of the image sensor, an observation to the Kalman filter

2. Obtaining, from the output of the vehicular motion sensor, a time update input related to the state of the estimation target, the time update input being used by the Kalman filter

3. Adding, to system noise of the Kalman filter, the previously defined correction that addresses variations of the error in the vehicular motion sensor.

A state estimation apparatus according to a third aspect of the present disclosure includes an image-sensor information acquisition port that acquires output information from an image sensor, and a vehicular-motion sensor information acquisition port that acquires output information from a vehicular motion sensor. The state estimation apparatus includes a memory in which a correction that addresses variations of an error in the vehicular motion sensor is stored, and a processing unit. The processing unit is configured to

(1) Extract, from the output information acquired by the image-sensor information acquisition port

(2) Obtain, based on the output information acquired by the vehicular-motion sensor information acquisition port, a time update input related to the state of the estimation target, the time update input being used by the Kalman filter

(3) Add the correction read from the memory to system noise of the Kalman filter

(4) Obtain an estimated value of the state of the estimation target as a function of the observation; the time update input; and the Kalman filter

A state estimation apparatus according to a fourth aspect of the present disclosure is a state estimation apparatus for obtaining, based on an observation of a first sensor, an estimated value of a state of an estimation target using a Kalman filter. The state estimation apparatus includes an estimator configured to obtain the estimated value of the state of the estimation target in accordance with

1. The observation of the first sensor

2. An output of a second sensor, the output of the second sensor being different from the observation of the first sensor, the output of the second sensor serving as a time update input related to the state of the estimation target

3. The Kalman filter to which a correction has been added

The correction is configured to address variations of the output of the second sensor.

Each of the first to fourth aspects of the present disclosure is configured to obtain an estimated value of the state of the estimation target in accordance with

1. The observation

2. The time update input

3. The Kalman filter to which the correction has been added, the correction being configured to address variations of the output of the vehicular motion sensor or second sensor, i.e. variations of an error in the output of the vehicular motion sensor or second sensor.

This configuration enables the state of the estimation target to be estimated based on the variations of the output of the vehicular motion sensor or second sensor, i.e. variations of an error in the output of the vehicular motion sensor or second sensor. This therefore results in an improvement of the estimation accuracy of the state of the estimation target.

### BRIEF DESCRIPTION OF THE DRAWINGS

Other aspects of the present disclosure will become apparent from the following description of embodiments with reference to the accompanying drawings in which:

FIG. 1 is a block diagram illustrating a lane recognition apparatus according to the first embodiment of the present disclosure;

FIG. 2 is a flowchart illustrating a lane recognition routine of the travelling lane recognition apparatus according to the first embodiment of the present disclosure;

FIG. 3 is a flowchart illustrating a lane parameter estimation routine of the lane recognition apparatus according to the first embodiment;

FIG. 4 is a block diagram illustrating a pedestrian detection apparatus according to the second embodiment of the present disclosure;

FIG. 5 is a graph for estimating a distance to a tracking target according to the second embodiment

FIG. 6 is a flowchart illustrating a pedestrian detection routine of the pedestrian detection apparatus according to the second embodiment;

FIG. 7 is a flowchart illustrating a pedestrian parameter estimation routine of the pedestrian detection apparatus according to the second embodiment;

FIG. 8 is a graph illustrating an advantageous effect obtained by an estimation method according to the first embodiment as compared with a conventional estimation method;

FIG. 9 is a graph illustrating an advantageous effect obtained by the estimation method according to the first embodiment as compared with the conventional estimation method; and

FIG. 10 is a graph illustrating an advantageous effect obtained by the estimation method according to the first embodiment as compared with the conventional estimation method.

### DETAILED DESCRIPTION OF EMBODIMENT

The following describes exemplary embodiments of the present disclosure with reference to the accompanying drawings. The following describes, as an example, a lane recognition apparatus according to the first embodiment for estimating route parameters, to which an estimation apparatus according to the present disclosure has been applied.

### First Embodiment

### System Configuration of Lane Recognition Apparatus

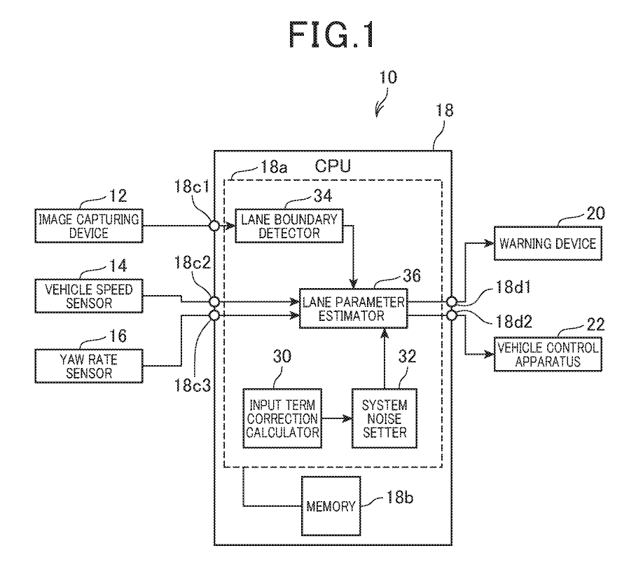

Referring to FIG. 1, a lane recognition apparatus 10 according to the first embodiment includes an image capturing device 12, a vehicle speed sensor 14, a yaw rate sensor 16, and a computer 18.

The image capturing device 12 captures, for example, a forward portion in front of an own vehicle. The computer 18 is configured to estimate route parameters related to a travelling route, on which the own vehicle is going to travel, in accordance with

(1) An image, captured by the image capturing device 12, of a forward portion of a road in front of the own vehicle, i.e. a travelling lane on which the own vehicle is going to travel

(2) The speed of the own vehicle measured by the vehicle speed sensor 14

(3) The yaw rate of the own vehicle, which is measured by the yaw rate sensor 16

This parameter estimation makes it possible for the computer 18 to carry out tracking of the travelling route.

The image capturing device 12 is an in-vehicle camera, and captures a forward portion of a road ahead of the own vehicle, such as the travelling lane on which the own vehicle is travelling. The image capturing device 12 is mounted to, for example, be close to the rear-view mirror of the own vehicle, and is operative to capture a road image ahead of the own vehicle as an image of the travelling lane on which the own vehicle is travelling.

The computer 18 includes a CPU 18a serving as a calculating unit, and a memory 18b connected to the CPU 18a, acquisition ports 18c1, 18c2, and 18c3 connected to the CPU 18a, and output ports 18d1 and 18d2 connected to the CPU 18a. The memory 18b includes a RAM and a ROM storing a program for running a lane parameter estimation routine. The acquisition ports 18c1 to 18c3 are operative to acquire information from the outside, and the output ports 18d1 and 18d2 are operative to output information externally

Specifically, the image capturing device 12, the vehicle speed sensor 14, and the yaw rate sensor 16 are connected to the computer 18 via the respective acquisition ports 18c1, 18c2, and 18c3. The CPU 18a, i.e. its functional blocks, is configured to obtain information obtained by each of the above devices 12, 14, and 16 via the corresponding one of the acquisition ports 18c1, 18c2, and 18c3.

The computer 18 of the lane recognition apparatus 10 is connected to a warning device 20 and a vehicle control apparatus 22 via the respective output ports 18d1 and 18d2. The warning device 20 is capable of outputting warnings to the driver of the own vehicle in response to information sent from the CPU 18a, i.e. its functional blocks, via the output port 18d1. The vehicle control apparatus 22 is capable of performing travelling control of the own vehicle in accordance with information sent from the CPU 18a, i.e. its functional blocks, via the output port 18d2.

Note that the acquisition ports 18c1, 18c2, and 18c3 are provided for the respective input devices 12, 14, and 18 as described above, or a common port can be provided for the input devices 12, 14, and 16.

Similarly, the output ports 18d1 and 18d2 are provided for the respective output devices 20 and 22 as described above, or a common port can be provided for the output devices 20 and 22.

The computer 18 is functionally configured as follows.

Specifically, the computer 18 includes an input term correction calculator 30, a system noise setter 32, a lane boundary detector 34, and a lane parameter estimator 36.

The input term correction calculator 30 is operative to calculate a correction for an error in an input term, i.e. an input yaw rate, of time update equations of an extended Kalman filter. The system noise setter 32 is operative to add the calculated correction to a system noise, which is a specific noise of the lane recognition apparatus 10, i.e. the system, to thereby set the extended Kalman filter.

The lane boundary detector 34 is operative to detect, based on the road image captured by the image capturing device 12, the boundaries of the lane on which the own vehicle is travelling. The lane parameter estimator 36 is operative to estimate lane parameters associated with the lane on which the own vehicle is travelling.

The lane boundary detector 34 detects, based on the road image captured by the image capturing device 12, the positions of white lines as the boundaries of the lane on which the own vehicle is travelling, which will be referred to as travelling lane.

Specifically, the lane boundary detector 34 extracts, from the road image, coordinate values of the position of each candidate point for white lines of the travelling lane. For example, the lane boundary detector 34 extracts a left white line or right white line of the lane on which the own vehicle is travelling.

Because white-line lane markings are usually painted on roads, the lane boundary detector 34 according to the first embodiment captures white-line lane markings as candidates of the boundaries for the travelling lane. The white-line lane markings have luminance levels higher than a luminance level of the lane surface. On the basis of this feature, the lane boundary detector 34 performs image processing, for example, feature extraction processing, on the road image using, for example, an available Sobel filter to thereby obtain, as the image-processing results, points, i.e. pixels, of an output image as candidate points for the white lines of the travelling lane; the pixel value of each of the points, i.e. pixels, is higher than a predetermined pixel value.

Each of the white-line lane markings has a locally continuous straight shape in the travelling direction. On the basis of this feature, the lane boundary detector 34 can limit the candidate points using, for example, a Hough transform such that some of the candidate points for the white lines of the travelling lane, which are aligned linearly, are defined finally as candidate points for the white lines of the travelling lane. Each of the white-line lane markings has a locally constant width. In view of this feature, the lane boundary detector 34 can match right and left candidate points of each candidate-point pair for a white-line lane marking with each other, and can select one or more candidate-point pairs whose adjacent right-and-left candidate points have the constant width to be defined finally as candidate points for the white lines of the travelling lane.

The lane parameter estimator 36 is configured to estimate, using the extended Kalman filter, lane parameters in accordance with the detected position of each candidate point of the travelling lane, i.e. the coordinate values of each candidate point for the white lines of the travelling lane; the lane parameters each represent the shape of the travelling lane of the own vehicle.

For example, the lane parameters include a curvature of the travelling lane, a change rate of the curvature of the travelling lane, and a lateral position of the own vehicle relative to the white lines.

Note that the coordinate values of each candidate point for a white line show the position of the corresponding candidate point on a two-dimensional coordinate system that is defined based on the road image. The two-dimensional coordinate system has, for example, an origin located at the upper left of the road image, a horizontal axis passing through the origin, and a vertical axis passing through the origin, and also has defined, as a positive direction, the right side and lower side relative to the origin.

Next, the following describes a theory for estimating the lane parameters using the extended Kalman filter.

First, the following describes calculation models used by the theory.

A state vector x of a lane recognition model is represented as the following equation (2-1):

x=[x₀θ₀c₀c₁ϕw]^{T} (2-1)

where

x₀ represents the lateral position [m] of the center of the own lane in the width direction

θ₀ represents the yaw angle [rad], i.e. an inclination of the lane

c₀ represents the curvature [1/m] of the road

c₁ represents the change rate [1/m²] of the curvature of the road

φ represents the pitch angle of the vehicle

w represents the lane width

A time update model from a lane parameter set xₜ₋₁ at time (t−1) to a lane parameter set xₜ at time t is represented by the following equation (2-2):

x_{t,t-1}=Fxₜ₋₁+Bω+u (2-2)

where

$$\begin{matrix}F = [ \begin{matrix}1 & VT & \frac{1}{2} {( VT )}^{2} & \frac{1}{6} {( VT )}^{3} & 0 & 0 \\ 0 & 1 & VT & \frac{1}{2} {( VT )}^{2} & 0 & 0 \\ 0 & 0 & 1 & VT & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] & ( 2 \text{-} 3 ) \\ B = [ \begin{matrix}- \frac{1}{2} {VT}^{2} \\ - T \\ 0 \\ 0 \\ 0 \\ 0\end{matrix} ] & ( 2 \text{-} 4 )\end{matrix}$$

where

V represents the measured vehicle speed [m/s]

ω represents the measured yaw rate [rad/s]

T represents update time of the Kalman filter

u represents system noise defined as Q=E[uu^{T]}

F represents a time update matrix of the state vector x

B represents a term contributed from the yaw rate a to the state vector x

Lane recognition usually observes, on the road image, while lines each continuously painted on the road surface, and obtains the coordinate values of each white-line candidate point on each of the white lines as an observation. Any white-line candidate point in the extracted white-line candidate points is referred to as a j-th white-line candidate point.

An observation function hⱼ(x) of the j-th white-line candidate point is expressed by the following equations:

$$\begin{matrix}{J}_{j} = {h}_{j} ( x ) = {J}_{c} + \frac{f}{{R}_{h}} [ \frac{( {x}_{0} + sw / 2}{t} + θ + \frac{{c}_{0} t}{2} + \frac{{c}_{1} {t}^{2}}{6} ] & ( 2 \text{-} 5 ) \\ t = \frac{{H}_{c}}{{R}_{v} ( {I}_{j} - {I}_{c} ) / f - φ} & ( 2 \text{-} 6 )\end{matrix}$$

where

Iⱼ represents the coordinate value, i.e. pixel, of the j-th white-line candidate point in the vertical direction

Jⱼ represents the coordinate value, i.e. pixel, of the j-th white-line candidate point in the horizontal direction

H_{c} represents the height [m] of the image capturing device, i.e. camera, 12 from the planer road surface

f represents the focal length [m] of the image capturing device, i.e. camera, 12

I_{c} represents the coordinate value, i.e. pixel, of the center of the road image in the vertical direction

J_{c} represents the coordinate value, i.e. pixel, of the center of the road image in the horizontal

Rᵥ represents the resolution [m/pixel] of the road image in the vertical direction

Rₕ represents the resolution [m/pixel] of the road image in the horizontal direction

s represents +1 if the j-th white-line candidate point on the road image is a right white-line candidate point in the lane or −1 if the j-th white-line candidate point on the road image is a left white-line candidate point in the lane

t represents a travelling-directional distance [m] relative to the vehicle upon the j-th white-line candidate point being projected on the planer road surface

Next, the update equations, i.e. time update equations, of the Kalman filter based on the above calculation modes including the lane recognition model and time update model are expressed by the following equations (2-7) and (2-8), and observation update equations are expressed by the following equations (2-9) to (2-12):

$$\begin{matrix}{x}_{t , t - 1} = {Fx}_{t - 1} + B ω & ( 2 \text{-} 7 ) \\ {P}_{t , t - 1} = {FP}_{t - 1} {F}^{T} + Q & ( 2 \text{-} 8 ) \\ {x}_{t} = {x}_{t , t - 1} + K [ y - h ( {x}_{t , t - 1} ) ] & ( 2 \text{-} 9 ) \\ {P}_{t} = {P}_{t , t - 1} - {KHP}_{t , t - 1} & ( 2 \text{-} 10 ) \\ K = {P}_{t , t - 1} {{H}^{T} [ {HP}_{t , t - 1} {H}^{T} + R ]}^{- 1} & ( 2 \text{-} 11 ) \\ H = \frac{\partial h ( x )}{\partial ( x )} & ( 2 \text{-} 12 )\end{matrix}$$

where P represents an error covariance matrix, H represents an observation matrix, R represents a variation matrix of observation noise, Q represents a variance matrix of system noise, and K represents a Kalman gain.

Next, the following describes a method of reducing the influence of a yaw rate error.

Considering the yaw rate error, i.e. measurement error, for the time update model equation (2-2) enables the time update model equation (2-2) to be expressed by the following equation (4-1):

x_{t,t-1}=Fxₜ₋₁+B(ωₛ+Δω)+u (4-1)

where (ωₛ+Δω) represents a measured value of the yaw rate, and ωₛ represents a real value of the yaw rate without containing the measurement error represented by Δω.

Revising the time update model equation (2-8) based on the yaw rate error enables the time update model equation (2-8) to be developed as follows assuming that x, ωₛ, Δω, and u are non-correlated with each other, the average of value of x is zero, and the average of values of ωₛ is zero.

Definition of the error covariance matrix enables the following equation (4-2) to be derived:

P_{t,t-1}=V(x_{t,t-1}−x̅_{t,t-1}) (4-2)

where x̅_{t,t-1} represents a predicted value of x_{t,t-1}.

Rewriting the equation (4-2) using a function E{ } indicative of average enables the following equation (4-3) to be obtained:

P_{t,t-1}=E{[x_{t,t-1}−x̅_{t,t-1}][x_{t,t-1}−x̅_{t,t-1}]^{T}} (4-3)

Because the measurement error Δω is contained in the time update equations based on the Kalman filter, the following equation (4-4) is obtained:

x̅_{t,t-1}=Fx̅_{t,t-1}+B(ωₛ+Δω) (4-4)

On the other hand, because the original system does not contain the yaw rate error, the following equation (4-5) is obtained:

xₜ=Fxₜ₋₁+Bωₛ+u (4-5)

Substituting the equations (4-4) and (4-5) into the equation (4-3) enables the following equation (4-6) to be obtained:

P_{t,t-1}=E{[(Fxₜ₋₁+Bωₛ+u)−(Fx̅ₜ₋₁+B(ωₛ+Δω))][(Fxₜ₋₁+Bωₛ+u)−(Fx̅ₜ₋₁+B(ωₛ+Δω))]^{T}} (4-6)

Arranging the equation (4-6) enables the following equations (4-7), (4-8), and (4-9) to be obtained:

P_{t,t-1}=E{[F(xₜ₋₁−\hat{x}ₜ₋₁)+u−BΔω][F(xₜ₋₁−\hat{x}ₜ₋₁)+u−BΔω]^{T}} (4-7)

P_{t,t-1}=E{F(xₜ₋₁−\hat{x}ₜ₋₁(xₜ₋₁−\hat{x}ₜ₋₁)^{T}F^{T}}+E{uu^{T}}+E{BΔωΔω^{T}B^{T}} (4-8)

P_{t,t-1}=FE{(xₜ₋₁−\hat{x}ₜ₋₁)(xₜ₋₁−\hat{x}ₜ₋₁)^{T}}F^{T}+E{uu^{T}}+E{BΔω}BB^{T} (4-9)

where E (Δω²) represents the mean square of the measurement error Δω of the yaw rate.

The above equations enable the following equation (4-10) to be obtained:

P_{t,t-1}=FPₜ₋₁F^{T}+Q+E{Δω}BB^{T} (4-10)

Therefore, replacing the Kalman filter update equation (2-8) with the equation (4-10) enables the yaw rate error Δω to be imported in the Kalman filter, resulting in reduction of steady-state deviations.

On the basis of the above described theory, the input term correction calculator 30 according to the first embodiment calculates a correction E{Δω²}BB^{T} of the error Δω of the yaw rate that is an input term, i.e. an input, to the time update equations of the extended Kalman filter. Then, the input term correction calculator 30 stores the calculated correction E{Δω²}BB^{T} in the memory 18b. Note that the yaw rate error Δω is a previously determined value. For example, the yaw rate error Δω is determined based on the resolution of the yaw rate sensor 16.

The system noise setter 32 reads out the correction E{Δω²}BB^{T} from the memory 18b, and adds the correction E{Δω²}BB^{T} to the system noise Q in accordance with the equation (4-10), thus setting the extended Kalman filter.

The lane parameter estimator 36 performs, based on the detected positions of the boundaries of the travelling lane, i.e. the coordinate values of the while-line candidate points of the travelling lane, a lane parameter estimation routine using the extended Kalman filter set by the system noise setter 32.

The estimation routine based on the extended Kalman filter includes a prediction step and a filtering step. The following describes the prediction step and filtering step carried out by the lane parameter estimator 36.

### Prediction Step

First, the following describes the operations in a current prediction step at time t.

The lane parameter estimator 36 calculates, based on the lane parameters xₜ₋₁ calculated at the immediately previous prediction step and the update matrix F included in the equation (2-3), lane parameters x_{t,t-1} at the time t in accordance with the equation (2-7).

Then, the lane parameter estimator 36 calculates, in accordance with the equation (4-10), a covariance matrix P_{t,t-1} as a function of

(1) The update matrix F included in the equation (2-3)

(2) The covariance matrix Pₜ₋₁ predicted in the immediately previous prediction step

(3) The variance matrix Q of the system noise

(4) The correction E{Δω²}BB^{T} of the yaw rate error Δω

### Filtering Step

Next, the following describes the operations in the filtering step.

In the filtering step, the lane parameter estimator 36 calculates, in accordance with the equation (2-11), the Kalman gain K as a function of

(1) The covariance matrix P_{t,t-1} calculated in the prediction step

(2) The observation matrix H

(3) The variance matrix R of the observation noise

Next, the lane parameter estimator 36 estimates, in accordance with the equation (2-9), lane parameters xₜ at the time t as a function of

(1) The calculated Kalman gain K

(2) The state vector x_{t,t-1} at the time t calculated in the prediction step

(3) The observations y, which are equal to h(x), calculated based on the observation matrix represented by the equation (2-5)

(4) The predicted values h(x_{t,t-1)}

(5) The observation matrix H represented by the equation (2-12)

Then, the lane parameter estimator 36 calculates, in accordance with the equation (2-10), the covariance matrix Pₜ as a function of

(1) The covariance matrix P_{t,t-1} predicted in the prediction step

(2) The calculated Kalman gain K

(3) The observation matrix H represented by the equation (2-12)

The values, i.e. the Kalman gain K, the lane parameters xₜ, and the covariance matrix Pₜ calculated in the filtering step are used by the operations in the next prediction step.

The lane parameter estimator 36 outputs the estimated lane parameters to the warning device 20 and the vehicle control apparatus 22. The warning device 20 is configured to output warnings indicative of lane deviation in accordance with the lateral position of the own vehicle included in the lane parameters. The vehicle control apparatus 22 is configured to perform a driving assist task and/or an autonomous driving task in accordance with each of the lane parameters.

Operations of Lane Recognition Apparatus 10

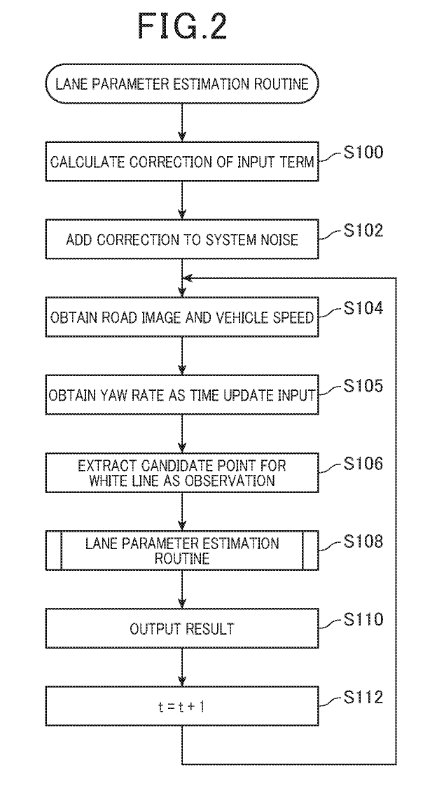

Next, the following describes the operations of the lane recognition apparatus 10 according to the first embodiment. First, the computer 18 carries out the lane recognition routine illustrated in FIG. 2 while

1. The own vehicle is travelling

2. A forward portion of the own vehicle is sequentially captured by the image capturing device 12

3. A value of the vehicle speed of the own vehicle is sequentially detected by the vehicle speed sensor 14

4. A value of the yaw rate is sequentially detected by the yaw rate sensor 16

### Lane Recognition Routine

In step S100, the input term correction calculator 30 calculates the correction E{Δω²}BB^{T} of the error Δω of the yaw rate that is an input term, i.e. an input or a time update input, to the time update equations of the extended Kalman filter. Then, the input term correction calculator 30 stores the calculated correction E{Δω²}BB^{T} in the memory 18b in step S100.

In step S102, the system noise reads out the correction E{Δω²}BB^{T} from the memory 18b, and adds the correction E{Δω²}BB^{T} to the system noise Q in accordance with the equation (4-10), thus setting the extended Kalman filter.

In step S104, the lane boundary detector 34 obtains a road image captured by the image capturing device 12, and the vehicle speed of the own vehicle measured by the vehicle speed sensor 14. In step S105, the lane boundary detector 34 obtains the yaw rate of the own vehicle, that is, the input, i.e. the input to be updated over time, to the time update equations.

In step S106, the lane boundary detector 34 extracts, from the road image, coordinate values of the position of each candidate point for white lines of the travelling lane as observations.

In step S108, the lane parameter estimator 36 estimates, based on the extended Kalman filter set by the system noise setter 32, the lane parameters as a function of

(1) The detected coordinate values of the position of each candidate point for white lines of the travelling lane

(2) The vehicle speed

(3) The yaw rate of the own vehicle

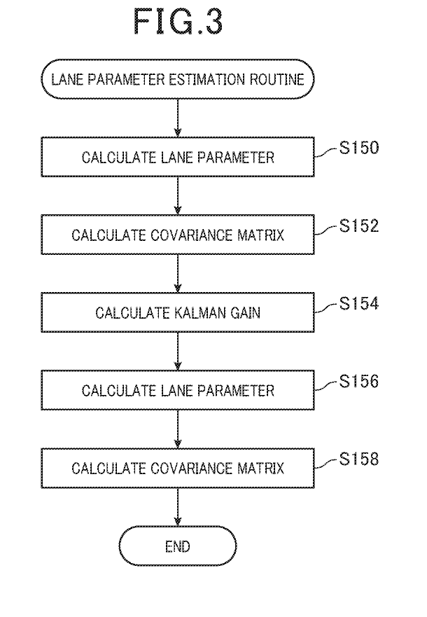

The operation in step S108 is implemented by the lane parameter estimation routine illustrated in FIG. 3.

### Lane Parameter Estimation Routine

In step S150, the lane parameter estimator 36 performs the operation in the prediction step to thereby calculate, based on the lane parameters xₜ₋₁ calculated in step S156 of the immediately previous routine and the update matrix F included in the equation (2-3), the lane parameters x_{t,t-1} at the time t in accordance with the equation (2-7).

In step S152, the lane parameter estimator 36 calculates, in accordance with the equation (4-10), the covariance matrix P_{t,t-1} as a function of

(1) The update matrix F included in the equation (2-3)

(2) The covariance matrix Pₜ₋₁ predicted in step S158 of the immediately previous routine

(3) The variance matrix Q of the system noise

(4) The correction E{Δω²}BB^{T} of the yaw rate error Δω

In the following step S154, the lane parameter estimator 36 performs the operation in the filtering step to thereby calculate, in accordance with the equation (2-11), the Kalman gain K as a function of

(1) The covariance matrix P_{t,t-1} calculated in step S152

(2) The observation matrix H

(3) The variance matrix R of the observation noise

In step S156, the lane parameter estimator 36 estimates, in accordance with the equation (2-9), the lane parameters xₜ at the time t as a function of

(1) The Kalman gain K calculated in step S154

(2) The state vector x_{t,t-1} at the time t calculated in step S150

(3) The observations y, which are equal to h(x), calculated based on the observation matrix represented by the equation (2-5)

(4) The predicted values h(x_{t,t-1})

(5) The observation matrix H represented by the equation (2-12)

In step S158, the lane parameter estimator 36 calculates, in accordance with the equation (2-10), the covariance matrix Pₜ as a function of

(1) The covariance matrix P_{t,t-1} estimated in step S152

(2) The Kalman gain K calculated in step S154

(3) The observation matrix represented by the equation (2-12)

The values, i.e. the Kalman gain K, the lane parameters xₜ, and the covariance matrix Pₜ calculated in the filtering step are used by the operations in the next prediction step.

Returning to the lane recognition routine, the lane parameter estimator 36 outputs, in step S110, the lane parameters obtained in step S108 to the warning device 20 and the vehicle control apparatus 22. In step S112, the lane parameter estimator 36 increments the time t by 1, returning to step S104.

As described above, the lane recognition apparatus according to the first embodiment uses the extended Kalman filter including the system noise to which the correction is added; the correction addresses or deals with the variations of the output of the yaw rate sensor, and the output of the yaw rate sensor is input to the time update equations of the state vector. This enables estimated values of the lane parameters to be obtained with higher accuracy even if there is an error in the output of the yaw rate sensor.

Setting the system noise based on the variations of the input term of the time update equations of the state vector, which may be ignored for conventional Kalman filters, enables steady-state deviations included in the estimated values due to the input term to immediately converge, resulting in reduction of the steady-state deviations included in the estimated values. That is, this enables the estimation accuracy in tracking of the lane based on the Kalman filter to be improved.

The lane recognition using the measured yaw rate of the own vehicle as an input and the image captured by the image capturing device 12 installed in the own vehicle results in improvement of the shape of the lane based on the lane parameters, such as the curvature of the lane even if there is an error in the measured yaw rate.

### Second Embodiment

### System Configuration of Pedestrian Detection Apparatus

Next, the following describes the second embodiment. The following describes, as an example, a pedestrian detection apparatus for estimating pedestrian parameters, to which an estimation apparatus according to the present disclosure has been applied.

In the embodiments, detailed descriptions about like parts between the embodiments, to which like reference characters are assigned, are omitted.

A pedestrian detection apparatus 210 according to the second embodiment is different from the first embodiment in the following point that the pedestrian detection apparatus 210 estimates pedestrian parameters in place of the lane parameters.

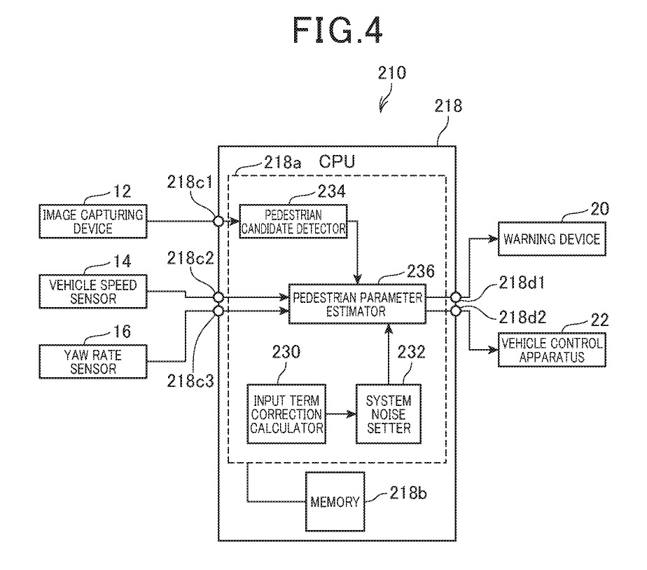

Referring to FIG. 4, the pedestrian detection apparatus 210 according to the second embodiment includes the image capturing device 12, the vehicle speed sensor 14, the yaw rate sensor 16, and a computer 218.

The computer 218 is configured to estimate pedestrian parameters in accordance with

(1) An image, captured by the image capturing device 12, of a forward portion of a road in front of the own vehicle, i.e. a travelling lane on which the own vehicle is going to travel

(2) The speed of the own vehicle measured by the vehicle speed sensor 14

(3) The yaw rate of the own vehicle, which is measured by the yaw rate sensor 16

This parameter estimation makes it possible for the computer 218 to carry out tracking of a pedestrian.

The computer 218 includes a CPU 218a serving as a calculating unit, and a memory 218b connected to the CPU 218a, acquisition ports 218c1, 218c2, and 218c3 connected to the CPU 218a, and output ports 218d1 and 218d2 connected to the CPU 218a. The memory 218b includes a RAM and a ROM storing a program for running a pedestrian parameter estimation routine. The acquisition ports 218c1 to 218c3 are operative to acquire information from the outside, and the output ports 218d1 and 218d2 are operative to output information to the outside.

Specifically, the image capturing device 12, the vehicle speed sensor 14, and the yaw rate sensor 16 are connected to the computer 218 via the respective acquisition ports 218c1, 218c2, and 218c3. The CPU 218a, i.e. its functional blocks, is configured to obtain information obtained by each of the above devices 12, 14, and 16 via the corresponding one of the acquisition ports 218c1, 218c2, and 218c3.

The computer 218 is connected to the warning device 20 and the vehicle control apparatus 22 via the respective output ports 218d1 and 218d2. The warning device 20 is capable of outputting warnings to the driver of the own vehicle in response to information sent from the CPU 218a, i.e. its functional blocks, via the output port 218d1. The vehicle control apparatus 22 is capable of performing travelling control of the own vehicle in accordance with information sent from the CPU 218a, i.e. its functional blocks, via the output port 218d2.

Note that the acquisition ports 218c1, 218c2, and 218c3 are provided for the respective input devices 12, 14, and 18 as described above, or a common port can be provided for the input devices 12, 14, and 16.

Similarly, the output ports 218d1 and 218d2 are provided for the respective output devices 20 and 22 as described above, or a common port can be provided for the output devices 20 and 22.

The computer 218 is functionally configured as follows.

Specifically, the computer 218 includes an input term correction calculator 230, a system noise setter 232, a pedestrian candidate detector 234, and a pedestrian parameter estimator 236.

The input term correction calculator 230 is operative to calculate a correction for an error in an input term, i.e. an input yaw rate, of time update equations of an extended Kalman filter. The system noise setter 232 is operative to add the calculated correction to a system noise to thereby set the extended Kalman filter.

The pedestrian candidate detector 234 is operative to detect, based on the road image captured by the image capturing device 12, pedestrian candidates located in front of the own vehicle. The pedestrian parameter estimator 236 is operative to estimate pedestrian parameters associated with at least one pedestrian located in front of the own vehicle.

The pedestrian candidate detector 234 detects, based on the road image captured by the image capturing device 12, the positions of pedestrian candidates located in front of the own vehicle. For example, the image capturing device 12 is comprised of a stereo camera, and the pedestrian candidate detector 234 detects, based on the road image captured by the stereo camera, the azimuth and distance from the own vehicle to each pedestrian candidate located in front of the own vehicle.

The pedestrian parameter estimator 236 is configured to estimate, using the extended Kalman filter, pedestrian parameters in accordance with the detected position of each pedestrian candidate, i.e. the azimuth and distance of each pedestrian candidate from the own vehicle; the pedestrian parameters include, for example, at least the position of a pedestrian and the distance of the pedestrian from the own vehicle.

Next, the following describes a theory for estimating the pedestrian parameters using the extended Kalman filter.

First, the following describes calculation models used by the theory.

The following describes a pedestrian as a tracking target, and describes, as an example, a case of execution of pedestrian detection while the own vehicle is moving while steer the own vehicle at the yaw rate ω.

The position of the tracking target is represented as positional coordinates (xₚ, zₚ) of the center point of the tracking target in a coordinate; the coordinate is defined to have

(1) A horizontal direction, i.e. an X coordinate direction, passing through the center of the travelling-directional head of the own vehicle above a road plane

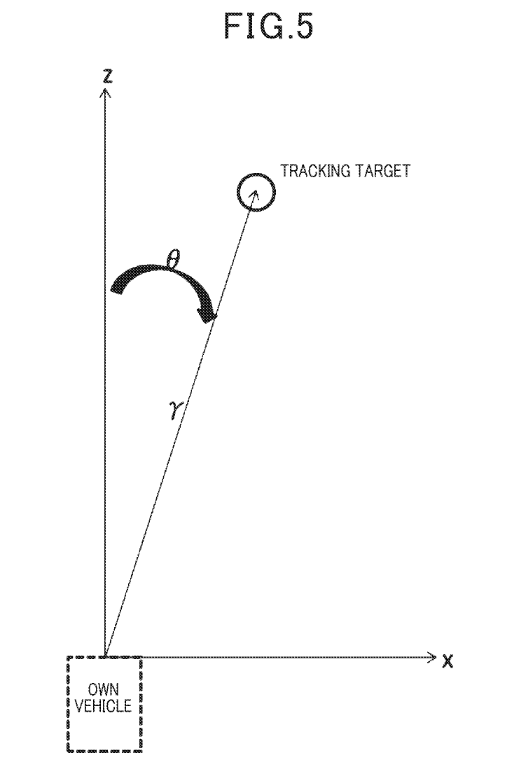

(2) A vertical direction, i.e. a Z coordinate direction, passing through the center of the travelling-directional head of the own vehicle above the road plane (see FIG. 5)

At that time, a state vector x of the Kalman filter is defined as the following equation (a-1):

x=└xₚ\dot{x}ₚzₚżₚ┘ (a-1)

where

xₚ represents the coordinate value [m] in the horizontal direction, i.e. the x-coordinate direction

\dot{x}ₚ represents the movement speed [m/s] of the tracking target in the x-coordinate direction

zₚ represents the coordinate value [m] in the vertical direction, i.e. the z-coordinate direction

żₚ represents the movement speed [m/s] of the tracking target in the z-coordinate direction

A time update model for the state vector x is represented by the following equation (a-2):

x_{t,t-1}=Fxₜ₋₁+B_{ω}ω+Bᵥv+u (a-2)

where

$$\begin{matrix}F = [ \begin{matrix}1 & T & 0 & 0 \\ 0 & 1 & 0 & 0 \\ 0 & 0 & 1 & T \\ 0 & 0 & 0 & 1\end{matrix} ] & ( a \text{-} 3 ) \\ {B}_{ω} = [ \begin{matrix}- {Tz}_{p} \\ - T {\dot{z}}_{p} \\ {Tx}_{p} \\ T {\dot{x}}_{p}\end{matrix} ] & ( a \text{-} 4 a ) \\ {B}_{v} = [ \begin{matrix}0 \\ 0 \\ - T \\ 0\end{matrix} ] & ( a \text{-} 4 b )\end{matrix}$$

where

ω represents the measured yaw rate [rad/s]

v represents the measured vehicle speed [m/s], i.e. the moving speed of the own vehicle in the z direction

T represents update time of the Kalman filter

u represents system noise defined as Q=E[uu^{T]}

F represents a time update matrix of the state vector x

B_{ω} represents a term contributed from the yaw rate a to the state vector x

Bᵥ represents a term contributed from the vehicle speed v to the state vector x

When a radar or a stereo camera detects a pedestrian or a front obstacle, an observation function h(x) is expressed by the following equations (a-5):

$$\begin{matrix}h ( x ) = [ \begin{matrix}θ \\ γ\end{matrix} ] \\ where & ( a \text{-} 5 ) \\ θ = {tan}^{- 1} ( \frac{{x}_{p}}{{z}_{p}} ) & ( a \text{-} 6 ) \\ γ = \sqrt{{x}_{p}^{2} + {z}_{p}^{2}} & ( a \text{-} 7 )\end{matrix}$$

At that time, the observations are θ and γ, θ represents the azimuth [rad] of the tracking target, i.e. the pedestrian candidate, relative to the own vehicle, and γ represents the distance [m] of the tracking target, i.e. the pedestrian candidate, relative to the own vehicle (see FIG. 5).

Next, the following describes the update equations of the Kalman filter.

The update equations based on the above calculation modes including the pedestrian recognition model and time update model are expressed by the following equations (a-8) and (a-9), and observation update equations are expressed by the following equations (a-10) to (a-13):

$$\begin{matrix}{x}_{t , t - 1} = {Fx}_{t - 1} + B ω & ( a \text{-} 8 ) \\ {P}_{t , t - 1} = {FP}_{t - 1} {F}^{T} + Q & ( a \text{-} 9 ) \\ {x}_{t} = {x}_{t , t - 1} + K [ y - h ( {x}_{t , t - 1} ) ] & ( a \text{-} 10 ) \\ {P}_{t} = {P}_{t , t - 1} - {KHP}_{t , t - 1} & ( a \text{-} 11 ) \\ K = {P}_{t , t - 1} {{H}^{T} [ {HP}_{t , t - 1} {H}^{T} + R ]}^{- 1} & ( a \text{-} 12 ) \\ H = \frac{\partial h ( x )}{\partial x} & ( a \text{-} 13 )\end{matrix}$$

where P represents an error covariance matrix, H represents an observation matrix, R represents a variation matrix of observation noise, Q represents a variance matrix of system noise, and K represents a Kalman gain.

Next, the following describes a method of reducing the influence of a yaw rate error and a vehicle speed error.

Replacing the Kalman filter update equation (a-9) with the following equation (a-14) enables the yaw rate error Δω and the vehicle speed error Δv to be imported in the Kalman filter, resulting in reduction of steady-state deviations of the tracking.

$$\begin{matrix}{P}_{t , t - 1} = {FP}_{t - 1} {F}^{T} + Q + E \{ Δ {ω}^{2} \} {B}_{ω} {B}_{ω}^{T} + E \{ Δ {v}^{2} \} {B}_{v} {B}_{v}^{T} \\ where & ( a \text{-} 14 ) \\ {B}_{ω} {B}_{ω}^{T} = [ \begin{matrix}{z}_{p}^{2} & {z}_{p} {\dot{z}}_{p} & - {x}_{p} {z}_{p} & - {\dot{x}}_{p} {z}_{p} \\ {z}_{p} {\dot{z}}_{p} & {\dot{z}}_{p} & - {x}_{p} {\dot{z}}_{p} & - {\dot{x}}_{p} {\dot{z}}_{p} \\ - {x}_{p} {z}_{p} & - {x}_{p} {\dot{z}}_{p} & {x}_{p}^{2} & {x}_{p} {\dot{x}}_{p} \\ - {\dot{x}}_{p} {z}_{p} & - {\dot{x}}_{p} {\dot{z}}_{p} & {x}_{p} {\dot{x}}_{p} & {\dot{x}}_{p}^{2}\end{matrix} ] \\ {B}_{v} {B}_{v}^{T} = [ \begin{matrix}0 & 0 & 0 & 0 \\ 0 & 0 & 0 & 0 \\ 0 & 0 & {T}^{2} & 0 \\ 0 & 0 & 0 & 0\end{matrix} ] & ( a \text{-} 15 )\end{matrix}$$

Δω represents the error [rad] in the yaw rate, and Δv represents the error [m/s] in the vehicle speed.

On the basis of the above described theory, the input term correction calculator 230 according to the second embodiment calculates a correction E{Δω²}BB^{T} of the error Δw of the yaw rate and a correction E{Δv²}BB^{T} of the error Δv of the vehicle speed; these corrections are each an input term, i.e. an input, to the time update equations of the extended Kalman filter. Then, the input term correction calculator 30 stores the calculated correction E{Δω²}BB^{T} and correction E{Δv²}BB^{T} in the memory 18b. Note that the yaw rate error Δω is a previously determined value. For example, the yaw rate error Δω is determined based on the resolution of the yaw rate sensor 16. Similarly, the vehicle speed error Δv is a previously determined value. For example, the vehicle speed error Δv is determined based on the resolution of the vehicle speed sensor 14.

For example, the input term correction calculator 230 the latest values of the parameters xₚ \dot{x}ₚ zₚ żₚ of the extended Kalman filter, and calculates the term B, based on the latest values of the parameters xₚ \dot{x}ₚ zₚ żₚ.

The system noise setter 232 reads out the correction E{Δω²}BB^{T} and the correction E{Δω²}BB^{T} from the memory 18b, and adds the correction E{Δω²}BB^{T} and correction E{Δv²}BB^{T} to the system noise Q in accordance with the equation (a-14), thus setting the extended Kalman filter.

The pedestrian parameter estimator 236 performs, based on the detected positions, i.e. the azimuths and distances, of the pedestrian candidates, a pedestrian parameter estimation routine using the extended Kalman filter set by the system noise setter 232.

The estimation routine based on the extended Kalman filter includes a prediction step and a filtering step. The following describes the prediction step and filtering step carried out by the pedestrian parameter estimator 236.

Prediction Step First, the following describes the operations in a current prediction step at time t.

The pedestrian parameter estimator 236 calculates, based on the pedestrian parameters xₜ₋₁ calculated at the immediately previous prediction step and the update matrix F included in the equation (a-3), pedestrian parameters x_{t,t-1} at the time t in accordance with the equation (a-8).

Then, the pedestrian parameter estimator 236 calculates, in accordance with the equation (a-14), a covariance matrix P_{t,t-1} as a function of

(1) The update matrix F included in the equation (a-3)

(2) The covariance matrix Pₜ₋₁ predicted in the immediately previous prediction step

(3) The variance matrix Q of the system noise

(4) The correction E{Δω²}BB^{T} of the yaw rate error Δω

(5) The correction E{Δv²}BB^{T} of the vehicle speed error Δv

### Filtering Step

Next, the following describes the operations in the filtering step.

In the filtering step, the pedestrian parameter estimator 236 calculates, in accordance with the equation (a-12), the Kalman gain K as a function of

(1) The covariance matrix P_{t,t-1} calculated in the prediction step

(2) The observation matrix H

(3) The variance matrix R of the observation noise

Next, the pedestrian parameter estimator 236 estimates, in accordance with the equation (a-10), pedestrian parameters xₜ at the time t as a function of

(1) The calculated Kalman gain K

(2) The state vector x_{t,t-1} at the time t calculated in the prediction step

(3) The observations y, which are equal to h(x), calculated based on the observation matrix represented by the equation (a-5)

(4) The predicted values h(x_{t,t-1})

(5) The observation matrix H represented by the equation (a-13)

Then, the pedestrian parameter estimator 236 calculates, in accordance with the equation (a-11), the covariance matrix Pₜ as a function of

(1) The covariance matrix P_{t,t-1} predicted in the prediction step

(2) The calculated Kalman gain K

(3) The observation matrix H represented by the equation (a-13)

The values, i.e. the Kalman gain K, the pedestrian parameters x_{t,t-1}, and the covariance matrix Pₜ calculated in the filtering step are used by the operations in the next prediction step.

The pedestrian parameter estimator 236 outputs the estimated pedestrian parameters to the warning device 20 and the vehicle control apparatus 22. The warning device 20 is configured to output warnings indicative of collision with pedestrians in accordance with the pedestrian positions included in the pedestrian parameters. The vehicle control apparatus 22 is configured to perform a driving assist task and/or an autonomous driving task in accordance with each of the lane parameters.

Operations of Pedestrian Recognition Apparatus 210

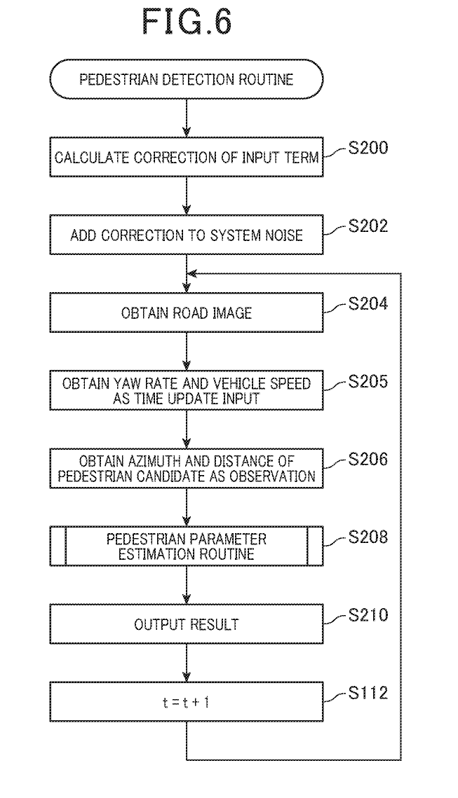

Next, the following describes the operations of the pedestrian recognition apparatus 210 according to the second embodiment. First, the computer 218 carries out the pedestrian detection routine illustrated in FIG. 6 while

1. The own vehicle is travelling

2. A forward portion of the own vehicle is sequentially captured by the image capturing device 12

3. A value of the vehicle speed of the own vehicle is sequentially detected by the vehicle speed sensor 14

4. A value of the yaw rate is sequentially detected by the yaw rate sensor 16

Note that detailed descriptions about like parts between the first and second embodiments, to which like reference characters are assigned, are omitted.

### Pedestrian Recognition Routine

In step S200, the input term correction calculator 230 calculates the correction E{Δω²}BB^{T} of the error Δω of the yaw rate and the correction E{Δv²}BB^{T} of the error Δv of the vehicle speed; these corrections are each an input term, i.e. an input, to the time update equations of the extended Kalman filter. Then, the input term correction calculator 230 stores the calculated correction E{Δω²}BB^{T} and correction E{Δv²}BB^{T} in the memory 18b in step S200.

In step S202, the system noise setter 232 reads out the correction E{Δω²}BB^{T} and the correction E{Δv²}BB^{T} from the memory 18b, and adds the correction E{Δω²}BB^{T} and correction E{Δv²}BB^{T} to the system noise Q in accordance with the equation (a-14), thus setting the extended Kalman filter.

In step S204, the pedestrian candidate detector 234 obtains a road image captured by the image capturing device 12, and the vehicle speed of the own vehicle measured by the vehicle speed sensor 14. In step S205, the pedestrian candidate detector 234 obtains the yaw rate of the own vehicle, that is, the input, i.e. time update input to be updated over time, to the time update equations.

In step S206, the pedestrian candidate detector 234 detects, based on the road image obtained in step S104, the azimuth and distance from the own vehicle to each pedestrian candidate as observations.

In step S208, the pedestrian parameter estimator 236 estimates, based on the extended Kalman filter, pedestrian parameters in accordance with

(1) The detected azimuth and distance of each pedestrian candidate from the own vehicle

(2) The vehicle speed

(3) The yaw rate of the own vehicle

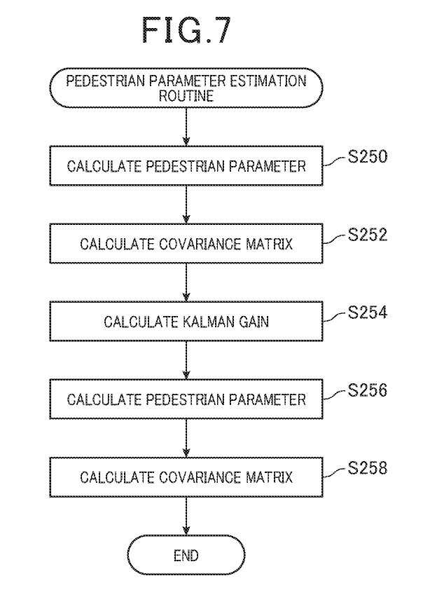

The operation in step S208 is implemented by the pedestrian parameter estimation routine illustrated in FIG. 7.

### Pedestrian Parameter Estimation Routine

In step S250, the pedestrian parameter estimator 236 performs the operation in the prediction step to thereby calculate, based on the pedestrian parameters xₜ₋₁ calculated in step S256 of the immediately previous routine and the update matrix F included in the equation (a-3), the lane parameters x_{t,t-1} at the time t in accordance with the equation (a-8).

In step S252, the pedestrian parameter estimator 236 calculates, in accordance with the equation (a-14), the covariance matrix P_{t,t-1} as a function of

(1) The update matrix F included in the equation (a-3)

(2) The covariance matrix Pₜ₋₁ predicted in step S258 of the immediately previous routine

(3) The variance matrix Q of the system noise

(4) The correction E{Δω²}BB^{T} of the yaw rate error a

(5) The correction E{Δv²}BB^{T} of the vehicle speed error Δv

In the following step S254, the pedestrian parameter estimator 236 performs the operation in the filtering step to thereby calculate, in accordance with the equation (a-12), the Kalman gain K as a function of

(1) The covariance matrix P_{t,t-1} calculated in step S252

(2) The observation matrix H

(3) The variance matrix R of the observation noise

In step S256, the pedestrian parameter estimator 236 estimates, in accordance with the equation (a-10), the pedestrian parameters xₜ at the time t as a function of

(1) The Kalman gain K calculated in step S254

(2) The state vector x_{t,t-1} at the time t calculated in step S250

(3) The observations y, which are equal to h(x), calculated based on the observation matrix represented by the equation (a-5)

(4) The predicted values h(x_{t,t-1})

(5) The observation matrix H represented by the equation (a-13)

In step S258, the pedestrian parameter estimator 236 calculates, in accordance with the equation (a-11), the covariance matrix Pₜ as a function of

(1) The covariance matrix P_{t,t-1} estimated in step S252

(2) The Kalman gain K calculated in step S254

(3) The observation matrix represented by the equation (a-13)

The values, i.e. the Kalman gain K, the lane parameters xₜ, and the covariance matrix Pₜ calculated in the filtering step are used by the operations in the next prediction step.

Returning to the pedestrian recognition routine, the pedestrian parameter estimator 236 outputs, in step S210, the pedestrian parameters obtained in step S208 to the warning device 20 and the vehicle control apparatus 22. In step S212, the pedestrian parameter estimator 236 increments the time t by 1, returning to step S204.

As described above, the pedestrian detection apparatus according to the second embodiment uses the extended Kalman filter including the system noise to which the corrections are added; the corrections address the variations of the output of the yaw rate sensor and the variations of the output of the vehicle speed sensor, and the outputs of the yaw rate sensor and vehicle speed sensor are input to the time update equations of the state vector. This enables estimated values of the pedestrian parameters to be obtained with higher accuracy even if there is an error in each of the output of the yaw rate sensor and the output of the vehicle speed sensor.

It is also possible to improve the estimation accuracy of the pedestrian parameters in tracking of pedestrians based on the Kalman filter.

The pedestrian recognition using the measured yaw rate of the own vehicle as an input and the image captured by the image capturing device 12 installed in the own vehicle results in improvement of the tracking accuracy of pedestrians even if there is an error in the measured yaw rate.

### Examples

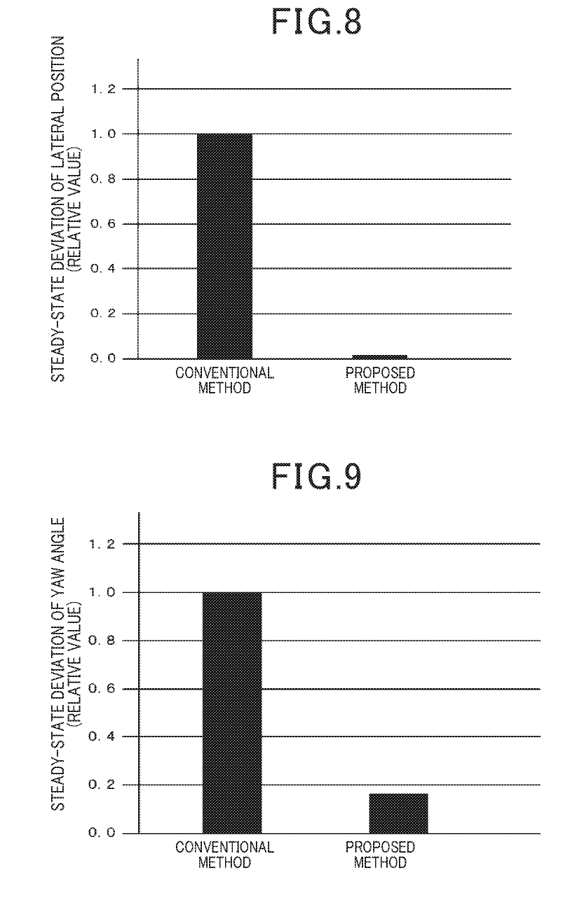

The following describes benefits obtained based on the lane parameter estimation routine carried out by the lane recognition apparatus 10 according to the first embodiment with reference to FIGS. 8 to 10.

FIG. 8 shows the simulation results, upon it being assumed that the radius of curvature of the road is 100 m and there is an error in the yaw rate input to the extended Kalman filter, obtained by comparing

(1) The steady-state deviations included in the estimated lateral positions of the own vehicle relative to a white line in accordance with the estimation method according to the first embodiment

(2) The steady-state deviations included in the estimated lateral positions of the own vehicle relative to the corresponding white line in accordance with a conventional estimation method

Specifically, FIG. 8 illustrates the simulation results upon an error being superimposed on the yaw rate input to the extended Kalman filter.

As illustrated in FIG. 8, the steady-state deviations included in the estimated lateral positions of the own vehicle relative to the white line in accordance with the estimation method according to the first embodiment are smaller than the steady-state deviations included in the estimated lateral positions of the own vehicle relative to the corresponding white line in accordance with the conventional estimation method; the conventional estimation method excludes an error being contained in the yaw rate input to the extended Kalman filter.

This results in verification of the advantageous effects obtained by the estimation method, i.e. proposed method, according to the first embodiment.

FIG. 9 shows the simulation results, upon it being assumed that the radius of curvature of the road is 100 m and there is an error in the yaw rate input to the extended Kalman filter, obtained by comparing

(1) The steady-state deviations included in the estimated yaw angles in accordance with the estimation method according to the first embodiment

(2) The steady-state deviations included in the estimated yaw angles in accordance with the conventional estimation method

Specifically, FIG. 9 illustrates the simulation results upon an error being superimposed on the yaw rate input to the extended Kalman filter.

As illustrated in FIG. 9, the steady-state deviations included in the estimated yaw angles in accordance with the estimation method according to the first embodiment are smaller than the steady-state deviations included in the estimated yaw angles in accordance with the conventional estimation method; the conventional estimation method excludes an error being contained in the yaw rate input to the extended Kalman filter.

This results in verification of the advantageous effects obtained by the estimation method according to the first embodiment.

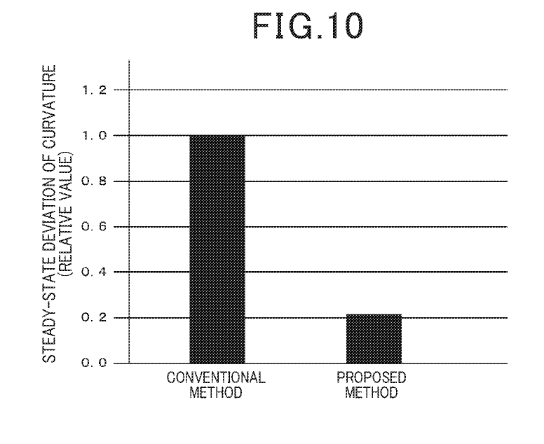

FIG. 10 shows the simulation results, upon it being assumed that the radius of curvature of the road is 100 m and there is an error in the yaw rate input to the extended Kalman filter, obtained by comparing

(1) The steady-state deviations included in the estimated curvatures of the road in accordance with the estimation method according to the first embodiment

(2) The steady-state deviations included in the estimated curvatures of the road in accordance with the conventional estimation method

Specifically, FIG. 10 illustrates the simulation results upon an error being superimposed on the yaw rate input to the extended Kalman filter.

As illustrated in FIG. 10, the steady-state deviations included in the estimated curvatures of the road in accordance with the estimation method according to the first embodiment are smaller than the steady-state deviations included in the estimated curvatures of the vehicle in accordance with the conventional estimation method; the conventional estimation method excludes an error being contained in the yaw rate input to the extended Kalman filter.

This results in verification of the advantageous effects obtained by the estimation method according to the first embodiment.

The extended Kalman filter described in the first embodiment or the second embodiment can be applied to a travelling lane recognition apparatus disclosed in the first published document.

The travelling lane recognition apparatus includes a CCD camera, a preprocessor, a small area setter for detection of lane markers, a straight line detector, a lane-marker candidate point detector, and a road model parameter calculator. The CCD camera captures road scenery in front of a vehicle, and the preprocessor applies a uniform process to the whole image based on video signals sent from the camera.

The small area setter sets a plurality of small areas on the input image; the small areas are operative to detect lane markers. The straight line detector detects a part of lane markers in each of the small areas.

The lane-marker candidate point detector verifies whether the straight-line detection result detected by each of the straight line detector matches with a part of a lane marker. The road model parameter calculator calculates, based on the detection results of the lane markers, road model parameters for representing the shape of the road in front of the vehicle.

In particular, the travelling lane recognition apparatus uses the extended Kalman filter described in the first embodiment or the second embodiment in calculating the road parameters, thus improving the lane recognition accuracy.

The extended Kalman filter described in the first embodiment or the second embodiment can also be applied to a vehicular information estimation apparatus disclosed in the second published document.

The vehicular information estimation apparatus, which is installed in a vehicle, includes a plurality of observation means, a reliability calculation means, and an estimation means. Each of the observation means performs an observation task associated with the vehicle to thereby output an observation. The reliability calculation means calculates a reliability of each of the observations output from the respective observation means. The estimation means inputs, to an estimation model, both the observation output from each observation means and the reliability of each the observations calculated by the reliability calculation means, thus estimating state quantities of the vehicle.

In particular, the observation means of the vehicular information estimation apparatus include at least one observation means that is configured to output at least first and second observations having the same type. The reliability calculation means calculates the reliability of each of the observations including the first and second same-type observations output from the same observation means.

When inputting the first and second same-type observations output from the same observation means to the estimation model, the estimation means uses the extended Kalman filter described in the first embodiment or the second embodiment, resulting in an improvement of the estimation accuracy of the vehicular state quantities.

The first and second embodiments uses a vehicle as a moving object, but can use another moving object.

Each of the first and second embodiments describes a corresponding one of a lane and a pedestrian as its tracking target, but can use an obstacle as its tracking target.

Each of the first and second embodiments can use a laser radar in place of the image capturing device 12. The laser radar is an active sensor that measures a distance to a target, and is capable of generating a road image based on received light intensities of respective reflected waves.

Note that the estimation methods and/or programs according to the first and second embodiments can be offered while each being stored in a storage medium.

The functions of one element in the embodiments can be distributed as plural elements, and one function of one element in the embodiments can be carried out by plural elements. The functions that plural elements have can be combined into one element. A function that plural elements have can be carried out by one element.

For example, the functions that the CPU 18a has can be shared by plural calculation apparatuses, i.e. CPUs communicable with the CPU 18a.

A part of the structure of each embodiment can be eliminated. At least part of the structure of each embodiment can be added to or replaced with the structure of the other embodiment. All aspects included in the technological ideas specified by the language employed by the claims constitute embodiments of the present invention.

### REFERENCE SIGNS LIST

10 Lane recognition apparatus
12 Image capturing device
14 Vehicle speed sensor
16 Yaw rate sensor
18, 218 Computer
20 Warning device
22 Vehicle control apparatus
30, 230 Input term correction calculator
32, 232 System noise setter
34 Lane boundary detector
36 Lane parameter estimator
210 Pedestrian detection apparatus
234 Pedestrian candidate detector
236 Pedestrian parameter estimator

What is claimed is:

1. A state estimation apparatus for estimating, based on an output of an image sensor, a state of an estimation target using a Kalman filter, the state estimation apparatus comprising:
an extracting unit configured to extract, from the output of the image sensor, an observation to be input to the Kalman filter;
an obtaining unit configured to obtain, from an output of a vehicular motion sensor that is different from the image sensor, a time update input related to the state of the estimation target, the time update input being used by the Kalman filter;
an estimator configured to obtain, based on the observation and the time update input, an estimated value of the state of the estimation target using the Kalman filter, the Kalman filter including system noise to which a previously defined correction has been added, the previously defined correction addressing variations of an error in the vehicular motion sensor.

2. The state estimation apparatus according to claim 1, wherein:
the output of the image sensor is comprised of an image of a travelling road of a moving object;
the observation is comprised of a position of a boundary of a lane on which the moving object is travelling, the position of the boundary of the lane being detected from the image of the road;
the time update input is comprised of a yaw rate measured by a yaw rate sensor that is the vehicular motion sensor; and
the estimated value of the state is comprised of a lane parameter that includes at least one of:
a position of the lane relative to the moving object;
an inclination of the lane relative to the moving object; and
a curvature of a portion of the lane, the portion of the lane being separated by a predetermined distance from the moving object.

3. The state estimation apparatus according to claim 1, wherein:
the output of the image sensor is comprised of an image of a road on which a moving object is travelling;
the observation is comprised of an azimuth and a distance of a pedestrian candidate relative to the moving object, the azimuth and distance of the pedestrian candidate being detected from the image of the road;
the time update input is comprised of a yaw rate measured by a yaw rate sensor that is the vehicular motion sensor; and
the estimated value of the state is comprised of a pedestrian parameter that includes at least one of:
a position of a pedestrian relative to the moving object; and
a moving speed of the pedestrian.

4. The state estimation apparatus according to claim 1, wherein:
a time update equation of the Kalman filter is comprised of the following equations:
x_{t,t-1}=Fxₜ₋₁+Bω
P_{t,t-1}=FPₜ₋₁F^{T}+Q+E{Δω²}BB^{T}
where:
x represents a state vector indicative of the state of the estimation target;
F represents a time update matrix of the state vector x;
B represents a term contributed from the output w of the yaw rate sensor as the vehicular motion sensor to the state vector x;
P represents an error covariance matrix;
H represents an observation matrix;
R represents a variation matrix of observation noise;
Q represents a variance matrix of system noise;
Δω represents a measurement error of the yaw rate sensor as the vehicular motion sensor; and
E{Δω²} represents a mean square of the measurement error Δω of the yaw rate sensor.

5. A state estimation method of estimating, based on a Kalman filter, a state of an estimation target as a function of: an output of an image sensor; an output of a vehicular motion sensor different from the image sensor; and a previously defined correction that addresses variations of an error in the vehicular motion sensor, the state estimation method comprising at least the steps of:
extracting, from the output of the image sensor, an observation to the Kalman filter;
obtaining, from the output of the vehicular motion sensor, a time update input related to the state of the estimation target, the time update input being used by the Kalman filter; and
adding, to system noise of the Kalman filter, the previously defined correction that addresses variations of the error in the vehicular motion sensor.

6. A state estimation apparatus comprising:
an image-sensor information acquisition port that acquires output information from an image sensor;
a vehicular-motion sensor information acquisition port that acquires output information from a vehicular motion sensor;
a memory in which a correction that addresses variations of an error in the vehicular motion sensor is stored;
a processing unit configured to:
extract, from the output information acquired by the image-sensor information acquisition port;
obtain, based on the output information acquired by the vehicular-motion sensor information acquisition port, a time update input related to the state of the estimation target, the time update input being used by the Kalman filter;
add the correction read from the memory to system noise of the Kalman filter; and
obtain an estimated value of the state of the estimation target as a function of the observation; the time update input; and the Kalman filter.

7. A state estimation apparatus for obtaining, based on an observation of a first sensor, an estimated value of a state of an estimation target using a Kalman filter, the state estimation apparatus comprising:
an estimator configured to obtain the estimated value of the state of the estimation target in accordance with:
the observation of the first sensor;
an output of a second sensor, the output of the second sensor being different from the observation of the first sensor, the output of the second sensor serving as a time update input related to the state of the estimation target; and
the Kalman filter to which a correction has been added, the correction being configured to address variations of the output of the second sensor.

8. The state estimation apparatus according to claim 7, wherein:
the observation of the first sensor is comprised of a position of a boundary of a lane on which a moving object is travelling, the position of the boundary of the lane being detected from an image of a travelling road of the moving object;
the second sensor being a yaw rate sensor;
the output of the second sensor being comprised of a yaw rate measured by the yaw rate sensor;
the estimated value of the state is comprised of a lane parameter that includes at least one of:
a position of the lane relative to the moving object;
a yaw angle; and
a curvature of a portion of the lane, the portion of the lane being separated by a predetermined distance from the moving object.

9. The state estimation apparatus according to claim 7, wherein:
the observation of the first sensor is comprised of an azimuth and a distance of a pedestrian candidate relative to the moving object, the azimuth and distance of the pedestrian candidate being detected from an image of a road on which the moving object is travelling;
the second sensor being a yaw rate sensor;
the output of the second sensor being comprised of a yaw rate measured by the yaw rate sensor; and
the estimated value of the state is comprised of a pedestrian parameter that includes at least one of:
a position of a pedestrian relative to the moving object; and
a moving speed of the pedestrian.

10. The state estimation apparatus according to claim 7, wherein:
a time update equation of the Kalman filter is comprised of the following equations:
x_{t,t-1}=Fxₜ₋₁+Bω
P_{t,t-1}=FPₜ₋₁F^{T}+Q+E{Δω²}BB^{T}
where:
x represents a state vector indicative of the state of the estimation target;
F represents a time update matrix of the state vector x;
B represents a term contributed from the output w of the yaw rate sensor as the vehicular motion sensor to the state vector x;
P represents an error covariance matrix;
H represents an observation matrix;
R represents a variation matrix of observation noise;
Q represents a variance matrix of system noise;
Δω represents a measurement error of the yaw rate sensor; and
E{Δv²} represents a mean square of the measurement error Δω of the yaw rate sensor.
